(19) United States
(12) Patent Application Publication
(10) Pub. No.: US 2025/0327697 A1
(43) Pub. Date: Oct. 23, 2025

(54) LINEAR EXCITATION FOR CORIOLIS MASS FLOW METER

(71) Applicant: Dionex Softron GmbH, Germering (DE)

(72) Inventor: Michael Haeckel, Germering (DE)

(73) Assignee: Dionex Softron GmbH, Germering (DE)

(21) Appl. No.: 19/185,176

(22) Filed: Apr. 21, 2025

(30) Foreign Application Priority Data
Apr. 22, 2024 (DE) 10 2024 111 152.6

(51) Int. Cl. G01F 1/84

(52) U.S. Cl. CPC G01F 1/8422; G01F 1/8413; G01F 1/8481

(57) ABSTRACT

The present disclosure relates to an excitation device for exciting an oscillation, comprising a fixable portion, a movable portion configured to move with respect to the fixable portion, a connection portion, wherein the movable portion is connected to the fixable portion via the connection portion, a piezo element fixedly mounted to the fixable portion, and a connecting element mechanically connecting the piezo element and the movable portion. Furthermore, a Coriolis flow meter comprising a measuring tube, at least one sensor configured to detect motion of the measuring tube, and an excitation device configured to excite an oscillation of the measuring tube is disclosed.

### CROSS-REFERENCE TO RELATED APPLICATION

This application claims priority from German patent application no. DE 10 2024 111 152.6, filed Apr. 22, 2024. The entire disclosure of DE 10 2024 111 152.6 is incorporated herein by reference.

### FIELD

The present disclosure generally relates to Coriolis mass flow meters and particularly to providing an excitation for Coriolis mass flow meters.

### BACKGROUND

At present, the flow rate of analytical liquid chromatography (LC) and high-performance liquid chromatography (HPLC) systems and thus also the composition of the mobile phase may be controlled solely by the operation of the pump, e.g., by the piston movement. That is, the piston movement may be measured during each pump stroke and the resulting flow rate may be inferred considering the displaced volume in the pumping chamber based on the piston movement. However, this may typically result in very high demands on the tightness of all involved components. Otherwise, the piston movement may not provide a good measure as fluid may leak out and therefore not contribute to the flow rate. This may however result in more complex and elaborate designs of the pumps, as well as higher demands on materials involved.

Furthermore, compressibility and thermal expansion of the fluid may require compensation, as they can influence the flow rate inferred from the displaced volume. Thermal expansion may not only occur due to changes of the ambient temperature but also due to adiabatic heating during the pumping process. Therefore, inferring the flow rate from the piston displacement may require careful calibration with respect to said fluid characteristics and thus, good knowledge of said fluid characteristics may be required, which can for example be particularly difficult when solvent gradients are used, i.e., when the composition of the mobile phase varies over time.

Thus, it would generally be desirable to measure the provided flow rate, which would allow to correct for deficiencies of the pump, e.g., by means of respective control mechanisms, and accuracy requirements for the pump could be relaxed. However, measuring the flow rate requires provision of an accurate and cost-effective flow sensor for a respective flow range, e.g., a flow range of 50 μl/min to 5 ml/min.

There are mainly three different types of sensors that could be used for flow measurements in HPLC applications: thermal mass flow meters, ultrasonic flow meters and Coriolis mass flow meters. However, currently no sensor appears to be widely used that can measure with sufficient accuracy in the desired flow and pressure range, e.g., a flow range of 50 μl/min to 5 ml/min and a pressure range of 5-150 MPa.

Currently, mainly thermal mass flow meters are used for low-flow HPLC. Each of the different sensor types offers certain advantages and disadvantages. For example, thermal mass flow meters and ultrasonic flow meters may depend on the characteristics of the fluid and thus also require careful calibration. One particular advantage of using a Coriolis mass flow meter is that it provides a linear response to the mass flow through the sensor and that it is independent of the fluid characteristics. Furthermore, it can advantageously also measure the density of the fluid independent of the mass flow measurement. In other words, a Coriolis mass flow meter is linear, solvent independent, and can also measure density, which in turn also allows to determine the volume flow rate.

Unlike current analytical HPLC pumps which control the volume flow, the retention times can be kept stable independent of the ambient temperature if the mass flow rate is kept constant. In other words, it may be advantageous to measure the mass flow rate instead of the volume flow since this may allow for stable retention times independent of the ambient temperature, i.e., without the need to further take into account and/or control the ambient temperature of the system. Therefore, it may be desirable to have a measurement of the mass flow rate which is inherently provided by a Coriolis mass flow meter.

In a Coriolis mass flow meter, a flow of fluid may generally be forced to move in a non-rectilinear manner through at least one tube, which may comprise a curved or straight tube geometry. The at least one tube is forced to oscillate and due to its rotational flow, the liquid causes a torsion on the at least one tube by means of the Coriolis force. The torsion may be measured by measuring the displacement of the tube in at least two locations, wherein one location may be upstream and the other location may be downstream of the centre of the tube in flow direction. Preferably, the two locations are arranged symmetrically around the centre of the tube in flow direction. Thus, the torsion may result in a phase shift between the overall oscillation measured at the two locations. Based on the measured torsion, e.g., the measured phase shift, the mass flow rate can be determined. Furthermore, a change in oscillation frequency may allow to measure the density of the fluid, as the natural frequency of the tube depends on the mass of the tube and the comprised fluid. Thus, it allows for a measurement of the fluid mass and based on the known volume of the tube, the density of the fluid.

Thus, it is necessary for a Coriolis mass flow meter to provide some form of excitation to the at least one tube (also referred to as measuring tube) in order to force it to oscillate. Usually, a small actuator may be attached to the at least one tube for this purpose. However, this may not be possible for small tubes, such as those needed for measuring small flow rates, because it would increase the mass of the tube significantly. Added mass, however, may disadvantageously reduce sensitivity of the Coriolis mass flow meter (or simply mass flow meter).

For mass flow meters designed for measuring low flow rates it is thus common to use an electromagnetic excitation as for example taught in EP 1 719 983 B1. However, since no additional components can be attached directly to the tube, the tube itself is used as an electrical conductor. Generally, such mass flow meters may disadvantageously be complex and consequently expensive for thin tubes.

Furthermore, approaches based on piezoceramics are known as for example disclosed in the Poster “MICRO CORIOLIS MASS FLOW SENSOR DRIVEN BY EXTERNAL PIEZO CERAMIC”, presented at the 3^{rd} Conference on MicroFluidic Handling systems, 4-6 Oct. 2017, Enschede, The Netherlands by Y. Zeng et al. (https://ris.utwente.nl/ws/portalfiles/portal/19542377/coriolis_piezo.pdf). This simple concept has the disadvantage that the excitation is not exactly symmetrical due to an asymmetry of the piezo and the mounting. As a result, in addition to the desired linear excitation, a rotational movement is also excited. This rotation creates a zero-point error in the flow signal, which may not be stable over time. This limits the accuracy of the of the sensor.

### SUMMARY

In light of the above, it is an object to overcome or at least alleviate the shortcomings and disadvantages of the prior art.

These objects are met by the present disclosure.

In one aspect, the present disclosure relates to an excitation device for exciting an oscillation, the excitation device comprising a fixable portion, a movable portion configured to move with respect to the fixable portion, a connection portion, wherein the movable portion is connected to the fixable portion via the connection portion, a piezo element fixedly mounted to the fixable portion, and a connecting element mechanically connecting the piezo element and the movable portion. It will be understood that the fixable portion is generally configured to be fixed to another element, e.g., a housing or body of a Coriolis flow meter. In other words, the excitation device comprises a movable portion that is connected to a fixable portion via a respective connection portion in such a way that the movable portion can move with respect to the fixable portion. The fixable portion may generally be configured to be fixed, e.g., mounted or attached, to another element. Furthermore, the excitation device comprises a piezo element that is attached to the fixable portion and mechanically connected to the movable portion.

The fixable portion may comprise at least one fixation means, preferably at least one tapped hole. The fixation means may aid with fixing the fixable portion to another element, e.g., a housing of a respective Coriolis flow meter.

The movable portion may be connected to the fixable portion via the connection portion such that at least part of the movable portion overlaps with the fixable portion. In other words, at least part of the movable portion may for example be located above the fixable portion such that there is a horizontal overlap between the two.

The excitation device may define a first direction (z), a second direction (x) perpendicular to the first direction, and a third direction (y) perpendicular to the first direction and to the second direction. In such a case, at least part of the movable portion may be located such that it overlaps with the fixable portion in the first direction.

The connection portion may be configured to allow the movable portion to move with respect to the fixable portion. For example, the connection portion may constitute a joint between the movable portion and the fixable portion.

The connection portion may be configured to only provide one angular degree or freedom. That is, the connection portion may only be movable in one plane.

The connection portion may be configured to only be movable parallel to a plane spanning in the first direction (z) and the second direction (x). Additionally or alternatively, the connection portion may be configured to supress and/or prevent movement of the movable portion in the third direction (y).

The connection portion may comprise a bendable portion. That is, the connection portion may be configured to bend when a respective force is applied, preferably via the movable portion, which may thus allow the movable portion to move with respect to the fixable portion.

The connection portion may comprise a joint. In particular, the joint may be a solid-state joint. The solid-state joint may be a solid-state hinge. Additionally or alternatively, the solid-state joint may comprise a flexure. A flexure may for example be a flexure joint, a flexure hinge or a flexure bearing.

The connection portion may be symmetric with respect to a connection symmetry plane. The connection symmetry plane is spanning in the first direction (z) and the second direction (x). Further, the connection portion may only allow for movements parallel to the connection symmetry plane.

In some embodiments, the excitation device may comprise a plurality of connection portions.

The piezo element may be configured to exert a force on the movable portion via the connecting element. Similarly, the piezo element may be configured to induce a movement of the movable portion with respect to the fixable portion via the connecting element.

The piezo element may comprise a piezoelectric material, e.g., a piezoelectric crystal or a piezoelectric ceramic.

The piezo element may be a piezoelectric actuator. In other words, it may generally be a transducer configured to convert electrical energy into a mechanical displacement or stress based on a piezoelectric effect.

The piezo element may be configured to exert a force in the first direction (z). It will be understood that a piezo element configured to exert a force in the first direction (z) may nonetheless also exert small (undesired) forces in the second and/or third direction. However, it may generally be designed to exert the force in the first direction (z), and forces in additional directions may be undesired byproducts, e.g., owing to fabrication limitations.

The piezo element may be configured to exert a periodic pushing force and/or a periodic pulling force on the movable portion via the connecting element to induce movement, preferably oscillation, of the movable portion with respect to the fixable portion. Thus, the piezo element may be configured to induce a periodic motion of the movable portion with respect to the fixable portion.

The excitation device may comprise an insulating member configured to electrically isolate the fixable portion from the piezo element. Additionally or alternatively, the excitation device may comprise an insulating connecting member configured to provide electrical insulation between the piezo element and the connecting element. It will be understood that in such embodiments, the connecting element may mechanically connect the piezo element and the movable portion via the insulating connecting member. In particular, the connecting member may be fixed to the piezo element via the insulating connecting member. The insulating connecting member may for example be glued to the piezo element. Additionally or alternatively, the insulating connecting member may be crimped to the connection element. Generally, the insulating member and/or insulating connecting member may allow to prevent an undesired electrical connection between the piezo element, and the fixable portion and/or movable portion. This may be of interest, as the piezo element may require relatively high voltages.

The piezo element may be mounted centrally to the fixable portion with respect to the third direction. Additionally or alternatively, the piezo element may be mounted to the fixable portion such that it is located centrally in the third direction (y) with respect to the movable portion.

The connecting element may comprise a rod. In some instances, the connecting element may be a rod. The rod may comprise a diameter of at most 1 mm, preferably at most 0.5 mm, more preferably at most 0.3 mm.

Generally, the connecting element may be configured to transmit a pushing force provided by the piezo element to the movable portion.

In some embodiments, the connecting element may be a wire. Generally, the connecting element may be configured to transmit a pulling force provided by the piezo element to the movable portion. It will be understood that in some embodiments, the connecting element may be configured to transmit a pushing and pulling force, e.g., embodiments wherein the connecting element comprises a rod.

The connecting element may be fixed to the movable portion by means of crimping or caulking.

Generally, the connecting element may extend along the first direction (z). In some embodiments, the connecting element may comprise a length in the first direction (z) in the range of 5-50 mm, preferably 5-20 mm, more preferably 8-15 mm.

In some embodiments, the connecting element may be fixed centrally to the movable portion with respect to the third direction (y).

The movable portion may be configured to receive a measuring tube. In some embodiments, the excitation device may comprise the measuring tube. The measuring tube may be fixed to the movable portion at two fastening points. The two fastening points may be located further from the connection portion in the second direction (x) than the point where the connecting element is fixed to the movable portion. Additionally or alternatively, the two fastening points may each be located at the same distance in the second direction (x) with respect to the connection portion.

The measuring tube may be arranged in loop between the two fastening points. The loop may be arranged between the fixable portion and the movable portion in a first direction (z). The loop may be symmetric with respect to a loop symmetry plane. Further, the loop symmetry plane may be spanning in the first direction (z) and the second direction (x). The loop symmetry plane may be identical to the connection symmetry plane. That is, loop is symmetric with respect to the connection symmetry plane.

The excitation device may be configured to only excite one eigenmode of the measuring tube. The eigenmode may be symmetric with respect to the loop symmetry plane. In some embodiments, the eigenmode may only comprise movement in the first direction (z).

The measuring tube may be fixed by means of crimping, caulking, soldering or welding. This may advantageously allow to ensure a secure fixation of the measuring tube to the movable portion.

A length of the measuring tube between the two fastening points may be in the range of 50-500 mm, preferably 100-200 mm, more preferably 120-180 mm. Additionally or alternatively, the measuring tube may comprise a diameter in the range of 0.2-1.0 mm, preferably 0.3-0.6 mm, more preferably 0.3-0.4 mm.

The measuring tube may be configured for a mass flow rate of at least 0-2 g/min, preferably 0-5 g/min, more preferably 0-10 g/min. Additionally or alternatively, the measuring tube may be configured to guide fluids at pressures of at least 0-30 MPa, preferably 0-100 MPa, more preferably 0-200 MPa. Additionally or alternatively, the excitation device may configured to oscillate the movable portion and/or the measuring tube fixed thereto at an oscillation frequency in the range of 50-500 Hz, preferably 80-200 Hz, more preferably 100-150 Hz.

The movable portion may be symmetric with respect to a movable-portion symmetry plane. The movable-portion symmetry plane may be spanning in the first direction (z) and the second direction (x). Additionally or alternatively, the movable-portion symmetry plane may be identical to the connection symmetry plane.

Similarly, the fixable portion may be symmetric with respect to a fixable-portion symmetry plane. The fixable-portion symmetry plane may be spanning in the first direction (z) and the second direction (x). Additionally or alternatively, the fixable-portion symmetry plane may be identical to the connection symmetry plane.

Generally, the excitation device may be symmetric with respect to a device symmetry plane. The device symmetry plane may be spanning in the first direction (z) and the second direction (x).

The movable portion may be configured such that inertial forces acting on the piezo element due to the movable portion are reduced and preferably prevented. That is, the moveable portion may be dimensioned and located such that respective inertial forces are at least reduced. For example, the movable portion may be configured to also provide a counterweight by extending horizontally in two opposing directions of the connecting portion. Generally, this may allow to shift the centre of mass of the movable portion close to an axis of rotation of the connection portion. In particular, the movable portion may be configured such that a centre of mass of the movable portion is located in the first direction (z) of the connection portion. Overall, this may advantageously allow to reduce inertial forces owing to the movable portion acting on the piezo element which may reduce stresses and thus potential damage to the piezo element.

In another aspect, the present disclosure relates to a Coriolis flow meter comprising a measuring tube, at least one sensor configured to detect motion of the measuring tube, and an excitation device as described above, which is configured to excite an oscillation of the measuring tube.

The measuring tube may be comprised by the excitation device. The Coriolis flow meter may preferably comprise 2 sensors. Generally, the at least one sensor may be an optical sensor.

The Coriolis flow meter may be configured to measure mass flow rates at least in the range of 0-2 g/min, preferably at least in the range of 0-5 g/min, more preferably at least in the range of 0-10 g/min. The Coriolis flow meter may be configured to measure mass flow rates at fluid pressures at least in the range of 0-30 MPa, preferably at least in the range of 0-100 MPa, more preferably at least in the range of 0-200 MPa.

In yet another aspect the present disclosure relates to a use of the excitation device as described herein or of the Coriolis flow meter as described herein to measure a mass flow rate. The mass flow rate may be in the range of 0-2 g/min, preferably at least in the range of 0-5 g/min, more preferably at least in the range of 0-10 g/min. Additionally or alternatively, the mass flow rate may be measured at fluid pressures in the range of 0-30 MPa, preferably in the range of 0-100 MPa, more preferably in the range of 0-200 MPa.

Below, reference will be made to excitation device embodiments. These embodiments are abbreviated by the letter “D” followed by a number. Whenever reference is herein made to “device embodiments”, these embodiments are meant.
D1. Excitation device for exciting an oscillation, comprising
   a fixable portion;
   a movable portion configured to move with respect to the fixable portion;
   a connection portion, wherein the movable portion is connected to the fixable portion via the connection portion;
   a piezo element fixedly mounted to the fixable portion; and
   a connecting element mechanically connecting the piezo element and the movable portion.
D2. Excitation device according to the preceding device embodiment, wherein the fixable portion comprises at least one fixation means, preferably at least one tapped hole.
D3. Excitation device according to any of the preceding device embodiments, wherein the movable portion is connected to the fixable portion via the connection portion such that at least part of the movable portion overlaps with the fixable portion.
D4. Excitation device according to any of the preceding device embodiments, wherein the excitation device defines a first direction (z), a second direction (x) perpendicular to the first direction, and a third direction (y) perpendicular to the first direction and to the second direction.
D5. Excitation device according to any of the preceding device embodiments, wherein the connection portion is configured to allow the movable portion to move with respect to the fixable portion.
D6. Excitation device according to any of the preceding device embodiments, wherein the connection portion constitutes a joint between the movable portion and the fixable portion.
D7. Excitation device according to any of the preceding device embodiments, wherein the connection portion is configured to only provide one angular degree or freedom.

That is, the connection portion may only be movable in one plane.
D8. Excitation device according to any of the preceding device embodiments with the features of embodiment D4, wherein the connection portion is configured to only be movable parallel to a plane spanning in the first direction (z) and the second direction (x).
D9. Excitation device according to any of the preceding device embodiments with the features of embodiment D4, wherein the connection portion is configured to supress and/or prevent movement of the movable portion in the third direction (y).
D10. Excitation device according to any of the preceding device embodiments, wherein the connection portion comprises a bendable portion.

That is, the connection portion may be configured to bend when a respective force is applied, preferably via the movable portion, which may thus allow the movable portion to move with respect to the fixable portion.
D11. Excitation device according to any of the preceding device embodiments, wherein the connection portion comprises a joint.
D12. Excitation device according to the preceding device embodiment, wherein the joint is a solid-state joint.
D13. Excitation device according to the preceding device embodiment, wherein the solid-state joint is a solid-state hinge.
D14. Excitation device according to any of the 2 preceding device embodiments, wherein the solid-state joint comprises a flexure.

A flexure may for example be a flexure joint, a flexure hinge or a flexure bearing.
D15. Excitation device according to any of the preceding device embodiments, wherein the connection portion is symmetric with respect to a connection symmetry plane.
D16. Excitation device according to the preceding device embodiment with the features of embodiment D4, wherein the connection symmetry plane is spanning in the first direction (z) and the second direction (x).
D17. Excitation device according to any of the 2 preceding device embodiments, wherein the connection portion only allows for movements parallel to the connection symmetry plane.
D18. Excitation device according to any of the preceding device embodiments, wherein the excitation device comprises a plurality of connection portions.
D19. Excitation device according to any of the preceding device embodiments, wherein the piezo element is configured to exert a force on the movable portion via the connecting element.
D20. Excitation device according to any of the preceding device embodiments, wherein the piezo element is configured to induce a movement of the movable portion with respect to the fixable portion via the connecting element.
D21. Excitation device according to any of the preceding device embodiments, wherein the piezo element comprises a piezoelectric material.
D22. Excitation device according to any of the preceding device embodiments, wherein the piezo element is a piezoelectric actuator.
D23. Excitation device according to any of the preceding device embodiments, wherein the piezo element is configured to exert a force in the first direction (z).
D24. Excitation device according to any of the preceding device embodiments, wherein the piezo element is configured to exert a periodic pushing force and/or a periodic pulling force on the movable portion via the connecting element to induce movement, preferably oscillation, of the movable portion with respect to the fixable portion.
D25. Excitation device according to any of the preceding device embodiments with the features of embodiment D4, wherein the piezo element is mounted centrally to the fixable portion with respect to the third direction (y).
D26. Excitation device according to any of the preceding device embodiments with the features of embodiment D4, wherein the piezo element is mounted to the fixable portion such that it is located centrally in the third direction (y) with respect to the movable portion.
D27. Excitation device according to any of the preceding device embodiments, wherein the excitation device comprises an insulating member configured to electrically isolate the fixable portion from the piezo element.
D28. Excitation device according to any of the preceding device embodiments, wherein the excitation device comprises an insulating connecting member configured to provide electrical insulation between the piezo element and the connecting element.

It will be understood that in such embodiments, the connecting element may mechanically connect the piezo element and the movable portion via the insulating connecting member. In particular, the connecting member may be fixed to the piezo element via the insulating connecting member.
D29. Excitation device according to the preceding device embodiment, wherein the insulating connecting member is glued to the piezo element.
D30. Excitation device according to any of the 2 preceding device embodiments, wherein the insulating connecting member is crimped to the connection element.
D31. Excitation device according to any of the preceding device embodiments, wherein the connecting element comprises a rod.
D32. Excitation device according to the preceding device embodiment, wherein the rod comprises a diameter of at most 1 mm, preferably at most 0.5 mm, more preferably at most 0.3 mm.
D33. Excitation device according to any of the preceding device embodiments, wherein the connecting element is configured to transmit a pushing force provided by the piezo element to the movable portion.
D34. Excitation device according to any of device embodiments DI to D30, wherein the connecting element is a wire.
D35. Excitation device according to any of the preceding device embodiments, wherein the connecting element is configured to transmit a pulling force provided by the piezo element to the movable portion.
D36. Excitation device according to any of the preceding device embodiments, wherein the connecting element is fixed to the movable portion by means of crimping or caulking.
D37. Excitation device according to any of the preceding device embodiments with the features of embodiment D4, wherein the connecting element extends along the first direction (z).
D38. Excitation device according to any of the preceding device embodiments with the features of embodiment D4, wherein the connecting element comprises a length in the first direction (z) in the range of 5-50 mm, preferably 5-20 mm, more preferably 8-15 mm.
D39. Excitation device according to any of the preceding device embodiments with the features of embodiment D4, wherein the connecting element is fixed centrally to the movable portion with respect to the third direction (y).
D40. Excitation device according to any of the preceding device embodiments, wherein the movable portion is configured to receive a measuring tube.
D41. Excitation device according to any of the preceding device embodiments, wherein the excitation device comprises the measuring tube.
D42. Excitation device according to the preceding device embodiment, wherein the measuring tube is fixed to the movable portion at two fastening points.
D43. Excitation device according to the preceding device embodiment with the features of embodiment D4, wherein the two fastening points are located further from the connection portion in the second direction (x) than the point where the connecting element is fixed to the movable portion.
D44. Excitation device according to any of the 2 preceding device embodiments with the features of embodiment D4, wherein the two fastening points are each located at the same distance in the second direction (x) with respect to the connection portion.
D45. Excitation device according to any of the 3 preceding device embodiments, wherein the measuring tube is arranged in loop between the two fastening points.
D46. Excitation device according to the preceding device embodiment with the features of embodiment D4, wherein the loop is arranged between the fixable portion and the movable portion in a first direction (z).
D47. Excitation device according to the 2 preceding device embodiments, wherein the loop is symmetric with respect to a loop symmetry plane.
D48. Excitation device according to the preceding device embodiment with the features of embodiment D4, wherein the loop symmetry plane is spanning in the first direction (z) and the second direction (x).
D49. Excitation device according to any of the 2 preceding device embodiments and with the features of D15, wherein the loop symmetry plane is identical to the connection symmetry plane.

That is, loop is symmetric with respect to the connection symmetry plane.
D50. Excitation device according to any of the 9 preceding device embodiments, wherein the excitation device is configured to only excite one eigenmode of the measuring tube.
D51. Excitation device according to the preceding device embodiment and with the features of D47, wherein the eigenmode is symmetric with respect to the loop symmetry plane.
D52. Excitation device according to any of the 2 preceding device embodiments with the features of embodiment D4, wherein the eigenmode only comprises movement in the first direction (z).
D53. Excitation device according to any of the 12 preceding device embodiments, wherein the measuring tube is fixed by means of crimping, caulking, soldering or welding.
D54. Excitation device according to any of the 13 preceding device embodiments, wherein a length of the measuring tube between the two fastening points is in the range of 50-500 mm, preferably 100-200 mm, more preferably 120-180 mm.
D55. Excitation device according to any of the 14 preceding device embodiments, wherein the measuring tube comprises a diameter in the range of 0.2-1.0 mm, preferably 0.3-0.6 mm, more preferably 0.3-0.4 mm.
D56. Excitation device according to any of the 15 preceding device embodiments, wherein the measuring tube is configured for a mass flow rate of at least 0-2 g/min, preferably 0-5 g/min, more preferably 0-10 g/min.
D57. Excitation device according to any of the 16 preceding device embodiments, wherein the measuring tube is configured to guide fluids at pressures of at least 0-30 MPa, preferably 0-100 MPa, more preferably 0-200 MPa.
D58. Excitation device according to any of the preceding device embodiments, wherein the excitation device is configured to oscillate the movable portion and/or the measuring tube fixed thereto at an oscillation frequency in the range of 50-500 Hz, preferably 80-200 Hz, more preferably 100-150 Hz.
D59. Excitation device according to any of the preceding device embodiments, wherein the movable portion is symmetric with respect to a movable-portion symmetry plane.
D60. Excitation device according to the preceding device embodiment with the features of embodiment D4, wherein the movable-portion symmetry plane is spanning in the first direction (z) and the second direction (x).
D61. Excitation device according to any of the 2 preceding device embodiments and with the features of D15, wherein the movable-portion symmetry plane is identical to the connection symmetry plane.
D62. Excitation device according to any of the preceding device embodiments, wherein the fixable portion is symmetric with respect to a fixable-portion symmetry plane.
D63. Excitation device according to the preceding device embodiment with the features of embodiment D4, wherein the fixable-portion symmetry plane is spanning in the first direction (z) and the second direction (x).
D64. Excitation device according to any of the 2 preceding device embodiments and with the features of D15, wherein the fixable-portion symmetry plane is identical to the connection symmetry plane.
D65. Excitation device according to any of the preceding device embodiments, wherein the excitation device is symmetric with respect to a device symmetry plane.
D66. Excitation device according to the preceding device embodiment with the features of embodiment D4, wherein the device symmetry plane is spanning in the first direction (z) and the second direction (x).
D67. Excitation device according to any of the preceding device embodiments, wherein the movable portion is configured such that inertial forces acting on the piezo element due to the movable portion are reduced and preferably prevented.
D68. Excitation device according to any of the preceding device embodiments and with the features of D4, wherein the movable portion is configured such that a centre of mass of the movable portion is located in the first direction (z) of the connection portion.

Below, reference will be made to Coriolis flow meter embodiments. These embodiments are abbreviated by the letter “F” followed by a number. Whenever reference is herein made to “flow meter embodiments”, these embodiments are meant.
F1. Coriolis flow meter comprising
   a measuring tube;
   at least one sensor configured to detect motion of the measuring tube; and
   an excitation device according to any of the preceding device embodiments, configured to excite an oscillation of the measuring tube.
F2. Coriolis flow meter according to the preceding flow meter embodiment, wherein the measuring tube is comprised by the excitation device.
F3. Coriolis flow meter according to any of the preceding flow meter embodiments, wherein the Coriolis flow meter comprises 2 sensors.
F4. Coriolis flow meter according to any of the preceding flow meter embodiments, wherein the at least one sensor is an optical sensor.
F5. Coriolis flow meter according to any of the preceding flow meter embodiments, wherein the Coriolis flow meter is configured to measure mass flow rates at least in the range of 0-2 g/min, preferably at least in the range of 0-5 g/min, more preferably at least in the range of 0-10 g/min.
F6. Coriolis flow meter according to any of the preceding flow meter embodiments, wherein the Coriolis flow meter is configured to measure mass flow rates at fluid pressures at least in the range of 0-30 MPa, preferably at least in the range of 0-100 MPa, more preferably at least in the range of 0-200 MPa.

Below, reference will be made to use embodiments. These embodiments are abbreviated by the letter “U” followed by a number. Whenever reference is herein made to “use embodiments”, these embodiments are meant.
U1. Use of the excitation device according to any of the preceding device embodiments or of the Coriolis flow meter according to any of the preceding flow meter embodiments to measure a mass flow rate.
U2. Use according to the preceding use embodiment, wherein the mass flow rate is in the range of 0-2 g/min, preferably at least in the range of 0-5 g/min, more preferably at least in the range of 0-10 g/min.

U3. Use according to any of the preceding use embodiments, wherein the mass flow rate is measured at fluid pressures in the range of 0-30 MPa, preferably in the range of 0-100 MPa, more preferably in the range of 0-200 MPa.

The present disclosure is presented with a particular focus on the measurement of a mass flow rate in liquid chromatography (LC) and more particularly high-performance liquid chromatography (HPLC). However, it will be understood that the present technology may also be used in the context of other applications with similar conditions, e.g., high pressures and volume flow rates in the μl/min to ml/min range, where precise measurements of the mass flow rate are advantageous.

### BRIEF DESCRIPTION OF THE DRAWING

Embodiments according to the present disclosure will now be described with reference to the accompanying drawing. These embodiments should only exemplify, but not limit, the present disclosure.

FIG. 1 depicts an exemplary embodiment of an excitation device.

### DETAILED DESCRIPTION

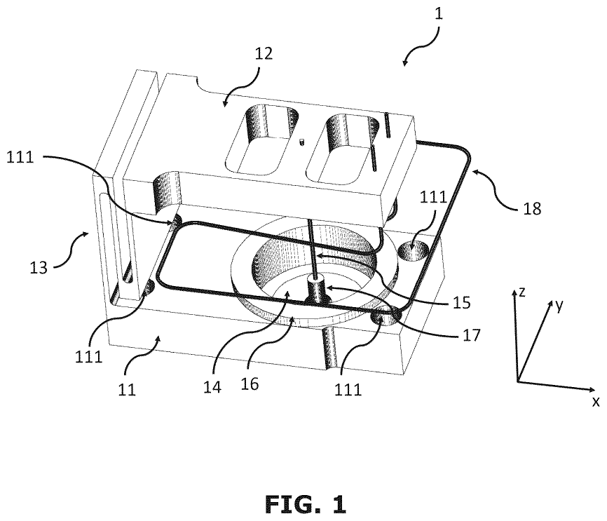

Generally, embodiments according to the present disclosure relate to an excitation device for exciting an oscillation. An exemplary embodiment of a respective excitation device is depicted in FIG. 1. The excitation device I generally comprises a fixable portion 11 and a movable portion 12, which is configured to move with respect to the fixed portion 11. It will be understood that the fixable portion 11 may generally be configured to be fixed to another element during operation of the excitation device, e.g., a body or housing of a respective Coriolis flow meter. The fixable portion 11 may for example comprise fixation means 111 for example at least one tapped hole 111.

Furthermore, the excitation device 1 comprises a connection portion 13 and the movable portion 12 is connected to the fixable portion 11 via the connection portion 13. The connection portion 13 may generally be configured to allow movement of the movable portion 12 with respect to the fixable portion 11. Thus, the connection portion 13 may provide a joint between the fixable portion 11 and the movable portion 12.

The movable portion 12 may be connected to the fixable portion 11 via the connection portion 13 such that the movable portion 12 and the fixable portion 11 at least partially overlap. More particularly, the movable portion 12 and the fixable portion 11 may overlap perpendicular to the z direction, i.e., they may have a common footprint.

Preferably, the connection portion 13 may provide only one angular degree of freedom. In other words, it may only be movable in one plane. This may advantageously allow to reduce and/or supress undesired angular movements of the movable portion 12 with respect to the fixable portion 11. In particular, it may be movable in or parallel to a plane spanning in the first direction (y-direction) and a second direction (x-direction), wherein the second direction (x-direction) is perpendicular to the first direction. In other words, the connection portion 13 may preferably only be movable parallel to the xz-plane. Thus, it may reduce and/or supress movement in a third direction (y-direction) which is perpendicular to the first direction (z-direction) and the second direction (x-direction).

The connection portion 13 may be a bendable portion 13. That is, the connection portion 13 may be configured to bend when a respective force is applied, preferably via the movable portion 12. This may allow the movable portion 12 to move with respect to the fixable portion 11 when a respective force is applied. Preferably, the connection portion 13 may be a joint and more preferably a solid-state joint, e.g., a solid-state hinge or flexure, e.g., a flexure joint, flexure hinge or flexure bearing.

The connection portion 13 may be symmetric with respect to a connection symmetry plane. In the embodiment depicted in FIG. 1 the connection portion is for example symmetric with respect to the connection symmetry plane spanning in the first direction (z-direction) and the second direction (x-direction), i.e., parallel to the xz-plane. Preferably, the connection portion 13 may only allow for movements parallel to the connection symmetry plane, thus limiting movement of the connection portion 13 to only one angular degree of freedom.

The movable portion 12 may similarly be symmetric with respect to a movable-portion symmetry plane. Preferably, also movable-portion symmetry plane may be spanning in the first direction (z-direction) and the second direction (x-direction). Further preferable, the movable-portion symmetry plane may be identical to the connection symmetry plane.

Further, the fixable portion 11 may similarly be symmetric with respect to a fixable-portion symmetry plane. Preferably, also fixable-portion symmetry plane may be spanning in the first direction (z-direction) and the second direction (x-direction). Further preferable, the fixable-portion symmetry plane may be identical to the connection symmetry plane.

In a preferred embodiment, the excitation device 1 may be symmetric with respect to a device symmetry plane. Again, the device symmetry plane may be spanning in the first direction (z-direction) and the second direction (x-direction). Thus, in such a case connection symmetry plane, movable-portion symmetry plane, fixable-portion symmetry plane and device symmetry plane may be identical, i.e., congruent.

Furthermore, the excitation device 1 comprises a piezo element 14 and a connecting element 15. The piezo element 14 is fixedly mounted to the fixable portion 11 and the connecting element 15 mechanically connects the piezo element 14 and the movable portion 12. Thus, the piezo element 14 may generally allow to induce a movement of the movable portion through the connecting element 15.

The piezo element 14 may be mounted centrally to the fixable portion 11 with respect to the third direction (y-direction). Thus, in case of a symmetric fixable portion 11, also the piezo element 14 may be symmetric with respect to the fixable-portion symmetry plane. Preferably, the piezo element 14 may be mounted to the fixable portion 11 such that it is located centrally in the third direction (y-direction) with respect to the movable portion 12. In other words, the piezo element 14 may be mounted to the fixable portion such that its projection on the movable portion in the first direction (z-direction) is located centrally with respect to the third direction (y-direction). Similarly, the connecting element 15 may preferably be fixed centrally to the movable portion 12 with respect to the third direction (y-direction). This may advantageously allow to avoid inducing any torque to the movable portion in the second direction (x-direction).

Thus, by connecting the movable portion 12 to the fixable portion 11 via the connection portion 13 and providing a mechanical connection between the piezo element 14 and the movable portion 12, a movement of the movable portion 12 with respect to the fixable portion 11 may be induced by the piezo element 14 which is fixed to the fixable portion 11. Furthermore, the connection portion 13 may restrict any movement of the movable portion 12 by preferably only providing one angular degree of freedom for the movement, which may advantageously allow to reduce and/or supress undesired angular movements of the movable portion 12 that could otherwise be induced to the piezoelectric element 14.

The piezo element 14 may comprise a piezoelectric material such as a piezoelectric single crystal, a piezoelectric ceramic and/or a piezoelectric thin-film. Thus, the piezo element 14 may also be referred to as piezoelectric element 14. In particular, the piezo element 14 may be a piezoelectric actuator. More generally, the piezo element 14 may be configured to provide a mechanical movement based on an applied electrical voltage utilizing the inverse piezoelectric effect. In particular, the piezo element may be configured to provide a periodic pushing or pulling force that allows to induce respective oscillation of the movable portion 12 with respect to the fixable portion 11 via the connecting element 15. The piezo element 14 may preferably be configured to provide a force acting in the first direction (z-direction).

The piezo element 14 may be electrically isolated from the fixable portion 11 through a respective electrical insulation, e.g., an insulating member 16. This may allow to prevent leakage of the electrical voltage applied to the piezo element 14 to the fixable portion 11. The excitation device I may further comprise an insulating connecting member 17 providing electrical insulation between the piezo element 14 and the connecting element 15. The insulating connecting member 17 may for example be crimped to the connection element 15 and/or glued to the piezo element 14.

The connecting element 15 may for example be a thin rod. The connecting element 15 may be fixed to the movable portion 12 by means of crimping, or caulking, i.e., forming a form-and force fitting connection. Generally, the connecting element 15 may be flexible while being sufficiently stiff to prevent it from buckling due to an axial pressure load, i.e. Euler's critical load must not be exceeded. For example, the connecting element may be a stainless steel rod, e.g. with a diameter of 0.3 mm and a length of 10 mm. This may advantageously allow to compensate angular errors if the piezo element 14 does not move exactly in the z-direction. Thus, the connecting element 15 may enable the piezo element 14 to push the movable portion 12 away from the piezo element 14 and thus the fixable portion 11, thereby inducing a respective movement thereof. Alternatively, the piezo element 14 may pull the movable portion towards the piezo element 14 and thus the fixable portion. In such a case the connecting element 15 may for example be a wire.

Generally, the movable portion 12 may be configured to receive a measuring tube 18. In some embodiments, the excitation device may comprise the measuring tube 18. In particular, the measuring tube 18 may be fixed to the movable portion at two fastening points. The measuring tube 18 may be symmetric with respect to the symmetry plane of the connection portion 13. That is, the measuring tube 18 may be arranged in a symmetric loop between the two fastening points.

The two fastening points may preferably be located further from the connection portion 13 in the second direction (x-direction) than the point at which the connecting element 15 is fixed to the movable portion 12. The fastening points may thus for example be located at an end of the movable portion that is opposite to a connection between the movable portion 12 and the connection portion 13, with the connecting element 15 being fixed to the movable portion 12 therebetween. This may advantageously allow to provide the greatest displacement of the movable portion 12 close to the fastening points.

The present disclosure may thus advantageously allow to controllably induce oscillation of the movable portion through the piezo element and thus oscillation of the measuring tube 18. In particular, the present disclosure may allow to only excite one eigenmode of the measuring tube, which is symmetrical to the x-z plane. The excitation of other eigenmodes with lateral vibration direction may advantageously be suppressed. Compared to a direct excitation with a piezo actuator, a higher measurement accuracy is achieved.

A length of the measuring tube 18 between the two fastening points may be in the range of 50-500 mm, preferably 100-200 mm. That is, there may be a respective flow distance in the specified range between the two fastening points.

In other words, the excitation device 1 comprises a fixable portion 11 and a movable portion 12, which are connected to each other via a connection portion 13, e.g., a solid joint. A piezo element, preferably a piezo actuator 14 is attached to the fixable portion. Optionally, there may be an electrical insulation 16 between the fixable portion 11 and the piezo element 14. A connecting element 15, e.g., a thin rod 15, is attached to both the piezo element 14 and the movable portion. An insulating connecting element 17, i.e., another electrically insulating body 17, may be located between the connecting element 15 and the piezo element 14. The insulating connecting element 17 can be attached to the connection element 15 by crimping and/or to the piezo element 14 by gluing, for example. That is, the connecting element 15 may be attached to the piezo element 14 via the insulating connecting element 17. The connecting element 15 can be attached to the movable portion 12 by crimping or caulking, for example. The measuring tube 18 which is to be excited to vibrate may be attached to the movable potion 12, for example by crimping, caulking, soldering or welding.

The connection portion 13 may comprise several loops, but it may also only consist of a single thin wall. It may be configured in such a way that it only allows movements parallel to the plane of symmetry (x-z) of the connection portion 13. In particular in the area where the measuring tube 18 is connected, this may predominantly a movement in the z-direction in the example. In particular, a rotation around the x-axis may be prevented by the connection portion.

The connecting element 15 may be a rod that is so thin that it is as flexible as possible, but nevertheless so stiff that it does not buckle due to an axial pressure load. This allows angular errors to be compensated for if the piezo element 14 does not move exactly in the z-direction. The movable portion 12 may extend across the connection portion 13 to form a

counterweight. Preferably, the counterweight is formed in such a way that the centre of mass of the movable portion 12 is very close to the axis of rotation of the connection portion 13. If high accelerations occur during transport of the device, this may advantageously allow that almost no inertial forces act on the piezo element 14 and stresses which might damage the piezo may be prevented.

It will be understood that the above merely serves as an exemplary embodiment of the present disclosure and that the movable portion 12, the fixable portion 11 and/or the connection portion 13 may for example comprise different shapes as depicted in FIG. 1. Additionally or alternatively, the excitation device 1 may in some embodiments for example comprise a plurality of connection portions 13.

Thus, the present disclosure may generally advantageously allow to decouple the direction of movement of the piezo element 14 form the direction of movement, e.g., vibration, of the measuring tube 18 in such a way that small angular errors are compensated and the movement occurs predominantly (preferably exclusively) in a desired direction. This may be achieved by transmitting the excitation via a connecting element, e.g., a flexible rod, to a movable portion 12 that is restricted in its direction of movement through a connection portion 13.

In particular, a connection portion, preferably a solid-state joint, is used, which may only allow movement in the desired direction and prevent unwanted rotational movement. For excitation, a piezo element 14, e.g., a piezo actuator, is connected to the connection portion via a connecting element 15, e.g., a thin rod, which can compensate for small angular errors. Thus, prerequisites for the piezo element 14 may be reduced and a low-cost piezo (bending) element can be used for excitation.

Thus, the present disclosure may enable a cost-effective vibration excitation of the measuring tube in a Coriolis mass flow meter with very high measuring accuracy for low flow rates (measuring range from approx. 1 mg/min up to approx. 10 g/min).

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawing, the skilled person will understand that this embodiment was provided for illustrative purpose only and should by no means be construed as limiting.

We claim:

1. An excitation device for exciting an oscillation, comprising:
a fixable portion;
a movable portion configured to move with respect to the fixable portion;
a connection portion, wherein the movable portion is connected to the fixable portion via the connection portion;
a piezo element fixedly mounted to the fixable portion; and
a connecting element mechanically connecting the piezo element and the movable portion.

2. Excitation device according to claim 1, wherein the connection portion is configured to allow the movable portion to move with respect to the fixable portion.

3. Excitation device according to claim 1, wherein the connection portion is configured to only provide one angular degree or freedom.

4. Excitation device according to claim 1, wherein the connection portion comprises a joint.

5. Excitation device according to claim 1, wherein the piezo element is configured to induce a movement of the movable portion with respect to the fixable portion via the connecting element.

6. Excitation device according to claim 1, wherein the excitation device comprises a measuring tube, and wherein the measuring tube is fixed to the movable portion at two fastening points.

7. Excitation device according to claim 6, wherein the excitation device is configured to only excite one eigenmode of the measuring tube.

8. Excitation device according to claim 6, wherein the measuring tube is configured for a mass flow rate of at least 0-2 g/min.

9. Excitation device according to claim 6, wherein the measuring tube is configured guide fluids at pressures of at least 0-30 MPa.

10. Excitation device according to claim 1, wherein the movable portion is connected to the fixable portion via the connection portion such that at least part of the movable portion overlaps with the fixable portion.

11. Excitation device according to claim 1, wherein the excitation device defines a first direction, a second direction perpendicular to the first direction, and a third direction perpendicular to the first direction and to the second direction, and wherein the connection portion is configured to only be movable parallel to a plane spanning in the first direction and the second direction, and wherein the connection portion is configured to supress and/or prevent movement of the movable portion in the third direction.

12. Excitation device according to claim 1, wherein the piezo element is configured to exert a periodic pushing force and/or a periodic pulling force on the movable portion via the connecting element to induce oscillation of the movable portion with respect to the fixable portion.

13. Excitation device according to claim 1, wherein the excitation device defines a first direction, a second direction perpendicular to the first direction, and a third direction perpendicular to the first direction and to the second direction, wherein the piezo element is configured to exert a force in the first direction, and wherein the piezo element is mounted to the fixable portion such that it is located centrally in the third direction with respect to the movable portion.

14. Excitation device according to claim 1, wherein the excitation device comprises an insulating member configured to electrically isolate the fixable portion from the piezo element.

15. Excitation device according to claim 1, wherein the connecting element comprises a rod, and wherein the connecting element is configured to transmit a pushing force provided by the piezo element to the movable portion.

16. Excitation device according to claim 1, wherein the connecting element comprises a wire, and wherein the connecting element is configured to transmit a pulling force provided by the piezo element to the movable portion.

17. Excitation device according to claim 1, wherein the movable portion is configured to receive a measuring tube such that at least a portion of the movable portion is arranged between the fixable portion and the movable portion.

18. A Coriolis flow meter comprising:
a measuring tube;
at least one sensor configured to detect motion of the measuring tube; and
the excitation device according to claim 1, configured to excite an oscillation of the measuring tube.

19. Coriolis flow meter according to claim 18, wherein the measuring tube is fixed to the movable portion at two fastening points, and wherein the measuring tube is arranged in a loop between the two fastening points.

20. Coriolis flow meter according to claim 19, wherein the loop is arranged between the fixable portion and the movable portion in a first direction.

21. Coriolis flow meter according to claim 19, wherein the loop is symmetric with respect to a loop symmetry plane, wherein the excitation device is configured to only excite one eigenmode of the measuring tube, and wherein the eigenmode is symmetric with respect to the loop symmetry plane.

22. Coriolis flow meter according to claim 21, wherein the movable portion receives the measuring tube such that the loop is arranged between the fixable portion and the movable portion in a first direction, and wherein the eigenmode only comprises movement in the first direction.
